(19) United States
(12) Patent Application Publication
(10) Pub. No.: US 2010/0042244 A1
(43) Pub. Date: Feb. 18, 2010

(54) METHOD OF DESIGNING TOOL AND TOOL PATH FOR FORMING A ROTOR BLADE INCLUDING AN AIRFOIL PORTION

(76) Inventors: Tahany Ibrahim El-Wardany, Bloomfield, CT (US); Changsheng Guo, South Windsor, CT (US); Daniel V. Viens, Mansfield Center, CT (US); Eric Fromerth, Manchester, CT (US); Lienjing Chen, Tolland, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/603,629

(22) Filed: Oct. 22, 2009

Related U.S. Application Data
(62) Division of application No. 11/782,666, filed on Jul. 25, 2007.

(51) Int. Cl. G06F 17/50

(52) U.S. Cl. 700/98; 700/103

(57) ABSTRACT

A method of designing a tool for forming a rotor blade including an airfoil portion includes generating a computer model of a rotor blade having an airfoil portion, and determining a curvature and radius of curvature at sections of the rotor blade. An inner and outer diameter of a circumferential forming portion of a tool operable to form the rotor blade may then be calculated. A method of designing a tool path for forming a rotor blade including an airfoil portion includes generating a computer model of a cylindrical tool operable to form a rotor blade including an airfoil portion and of a rotor having a plurality of the rotor blades. The computer models of the rotor and tool are used to generate a first and second tool motion corresponding to airfoil suction and pressure portions. A method of forming a rotor with integral blades is also disclosed.

### RELATED APPLICATION

This application is a divisional of U.S. patent application Ser. No. 11/782,666, which was filed Jul. 25, 2007.

### BACKGROUND OF THE INVENTION

This invention relates to a tool for forming a rotor blade including an airfoil portion, and more particularly to a method for designing a tool and a tool path for forming a rotor blade including an airfoil portion.

Gas turbine engines include several sections. The engine may include a fan, and does include a compressor and turbine. The fan, compressor, and turbine sections all include a rotor carrying blades. Recently, the fan and compressor rotor and blades may be an integrally bladed rotor (“IBR”). An IBR is a disk-shaped rotor comprising a center hub portion, and a plurality of integral blades extending radially outwards from the hub. Each blade can have complex geometric dimensional requirements, such as the portion of a blade forming an airfoil. The rotor and airfoils are typically machined from a pre-form or block of material.

One method of forming an airfoil from the pre-form is to use a cup tool with an inner machining surface that forms a suction side of an airfoil blade and an outer machining surface that forms a pressure side of an airfoil blade, as described in U.S. Utility application Ser. No. 10/217,423. However, such a cup tool must be specifically created for a desired IBR to ensure that each rotor blade of the IBR is formed properly and that adjacent rotor blades are not undesirably gouged by the tool. Also, it is difficult to obtain an appropriate tool path that such a cup tool may follow to form an airfoil portion on each rotor blade of an IBR.

There is a need for a method for designing a tool and a tool path for forming a rotor blade including an airfoil portion.

### SUMMARY OF THE INVENTION

A method of designing a tool for forming a rotor blade, including an airfoil, includes generating a computer model of a rotor blade including the airfoil shape, and determining a curvature and a radius of curvature at sections of the rotor blade. An inner diameter and an outer diameter of a circumferential forming portion of a tool operable to form the rotor blade, including the airfoil portion, may then be calculated. The forming portion of the tool is formed on both an inner peripheral surface and an outer peripheral surface of a cylindrical body portion of the tool. An outer radius of the forming portion should be less than a minimum curvature radius of an airfoil portion corresponding to a pressure side. An inner radius of the forming portion should be greater than a maximum curvature radius of an airfoil portion corresponding to a suction side.

A method of designing a tool path for forming a rotor blade including an airfoil portion includes generating a computer model of a cylindrical tool operable to form a rotor blade including an airfoil portion, and a computer model of a rotor having a plurality of the rotor blades. The computer model of the rotor and the computer model of the tool are used to generate a first tool motion corresponding to an airfoil suction portion and a second tool motion corresponding to an airfoil pressure portion.

These and other features of the present invention can be best understood from the following specification and drawings, the following of which is a brief description.

### BRIEF DESCRIPTION OF THE DRAWINGS

FIG. 1 illustrates an example integrally bladed rotor.

FIG. 2 illustrates a cross section of an example airfoil portion.

FIG. 3a illustrates how a tool forms an airfoil suction portion.

FIG. 3b illustrates how the tool of FIG. 3a forms an airfoil pressure portion.

FIG. 4a illustrates the tool of FIGS. 3a, 3b.

FIG. 4b illustrates a cross section of the tool of FIGS. 3a, 3b.

FIG. 5 illustrates how the tool of FIGS. 3a, 3b may tilt to contact a rotor blade.

FIG. 6 illustrates a sectional view of an example rotor blade.

FIG. 7 illustrates a curvature of an example rotor blade suction portion and pressure portion at a first angle.

FIG. 8 illustrates a radius of curvature of an example suction portion at the first angle.

FIG. 9 illustrates a curvature of an example suction portion and pressure portion at a second angle.

FIG. 10 illustrates a rough tool.

FIG. 11 illustrates an edge tool.

FIG. 12a illustrates a relationship between a cross section of the tool of FIGS. 3a, 3b and a rotor.

FIG. 12b illustrates a relationship between another cross section of the tool of FIGS. 3a, 3b and a rotor.

FIG. 13 is a flow chart illustrating an example method of forming a plurality of airfoils.

FIG. 14 is a flow chart illustrating an example tool creation process and an example tool path creation process for the tool of FIGS. 3a, 3b.

### DETAILED DESCRIPTION OF THE PREFERRED EMBODIMENT

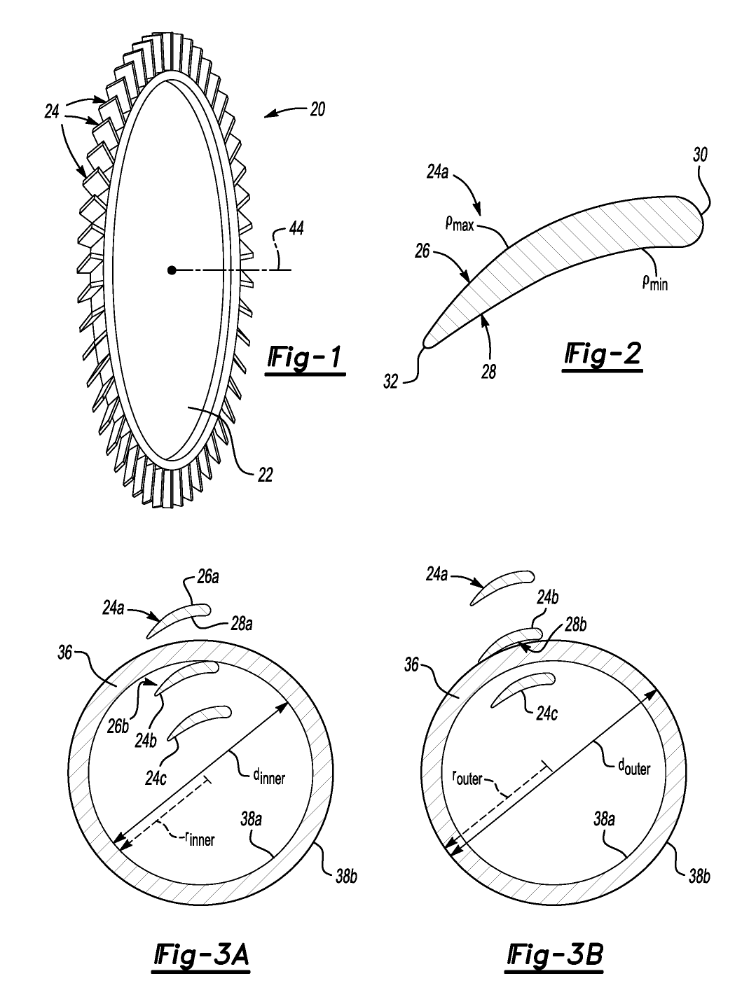

FIG. 1 illustrates an example integrally bladed rotor (“IBR”) 20 having a center portion or hub 22 and a plurality of blades 24 extending radially outward from the hub 22. An IBR axis 44 passes through a center of the IBR 20 and is perpendicular to a surface of the IBR 20. Each of the plurality of blades 24 includes a portion having an airfoil shape.

FIG. 2 illustrates a cross section of an example rotor blade 24a having an airfoil shape. The rotor blade 24a has a generally convex suction side 26, a generally concave pressure side 28, a leading edge 30, and a trailing edge 32. A maximum curvature radius of the suction side 26 occurs at a point ρₘₐₓ. A minimum curvature radius of the pressure side 28 occurs at a point ρₘᵢₙ.

FIG. 3a illustrates three rotor blades 24a, 24b, and 24c and a tool 36 having a tool inner side 38a and a tool outer side 38b. The tool inner side 38a has an inner diameter dᵢₙₙₑᵣ and an inner radius rᵢₙₙₑᵣ. The tool 36 and the rotor blade 24b are positioned so that the tool inner side 38a contacts a first side of the rotor blade 24b. The tool 36 rotates so that the tool inner side 38a contacts the rotor blade 24b to remove excess portions of the rotor blade 24b to form a suction side 26b of the rotor blade 24b. The rotor blade 24b may be tilted to facilitate contact between the tool inner side 38a with the entire suction side 26b of the rotor blade 24b.

As shown in FIG. 3b, the tool outer side 38b has an outer diameter dₒᵤₜₑᵣ and an outer radius rₒᵤₜₑᵣ. The tool 36 and the rotor blade 24b are positioned so that the tool outer side 38b contacts a second side of the rotor blade 24b. The tool 36 rotates so that the tool outer side 38b contacts the rotor blade 24b to form a suction side 28b of the rotor blade 24b. The rotor blade 24b may be tilted to facilitate contact between the tool outer side 38b with the entire pressure side 28b of the rotor blade 24b.

The tool 36 could then be used to form rotor blade 24a or 24c into an airfoil, and could continue until every rotor blade 24 of an IBR was formed into an airfoil. While FIGS. 3a and 3b show the tool 36 creating an airfoil suction side 26 and then an airfoil pressure side 28, it is understood that the tool 36 could also create the pressure side 28 first and then create a suction side 26.

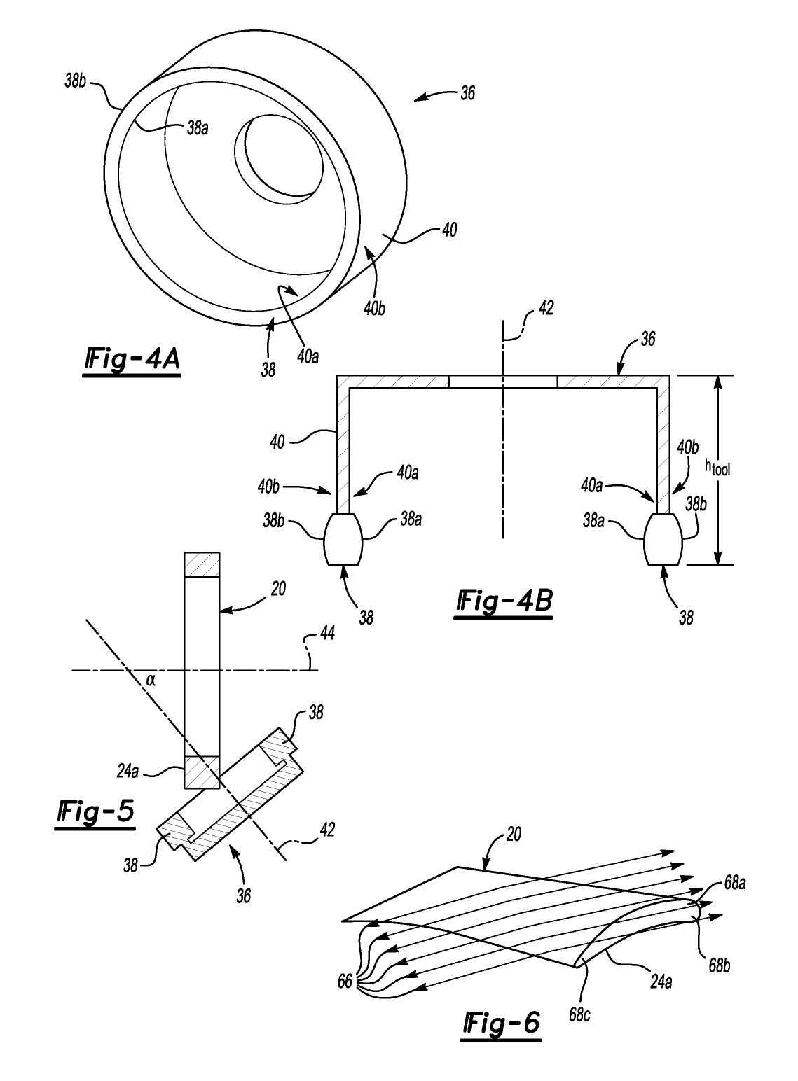

FIG. 4a illustrates the tool 36. The tool 36 has a cylindrical body 40 and a circumferential forming portion 38 formed on both an inner peripheral surface 40a of the cylindrical body 40 and an outer peripheral surface 40b of the cylindrical body 40. As mentioned above, the forming portion has an inner side 38a and an outer side 38b. In one example the forming portion 38 performs a grinding function when contacting a rotor blade or pre-form. FIG. 4b illustrates a cross section of the tool 36. As shown in FIG. 4b, the forming portion 38 is curved so that the inner side 38a and the outer side 38b have a generally convex shape. A height of the tool is indicated by the variable hₜₒₒₗ. In one example the cylindrical body 40 is made of steel and the forming portion 38 is made of cubic boron nitride. Of course, other materials can be used for the body and the forming portion. The tool 36 is operable to rotate about a central tool axis 42.

FIG. 5 illustrates an example of how the tool 36 may tilt to contact the rotor blade 24a. However it is understood that instead of moving the tool 36 it would also be possible to move the IBR 20. The tool 36 rotates about the tool axis 42 to contact the rotor blade 24a. An angle of intersection between the tool axis 42 and the IBR axis 44 is indicated by the angle α. The value of α varies depending on an orientation of the tool 36. As the tool 36 tilts, the value of α varies with respect to the IBR axis 44. The tool 36 is operable to move in 5 axes, which includes moving in a direction of a x, y, and z axis, and also rotating about two axes, as shown in FIG. 5.

FIG. 6 illustrates a sectional view of the rotor blade 24a of the IBR 20. The rotor blade 24a is divided into a plurality of sections 68a, 68b, and 68c by a plurality of dividers 66. The dividers 66 are imaginary, and do not correspond to an actual component on the rotor blade 24a. Also, it is understood that an orientation of the dividers 66 may differ from the example of FIG. 6.

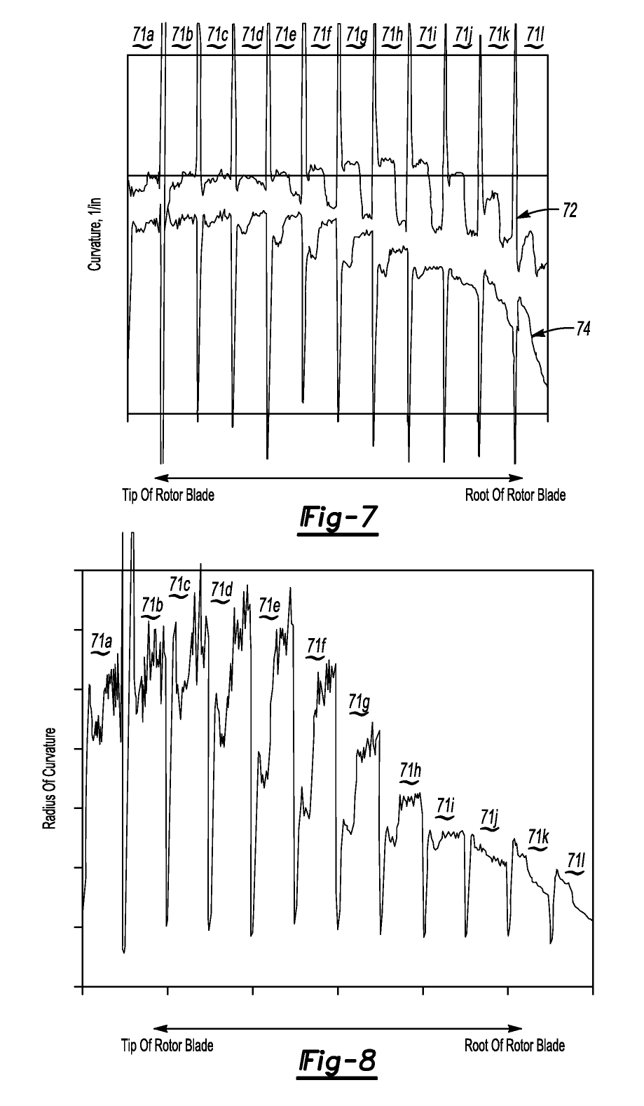

FIG. 7 illustrates a curvature of an example rotor blade suction portion 74 and an example rotor blade pressure portion 72 when α is 90 degrees. In the example of FIG. 7, the example rotor blade is divided into 12 sections, 71a-1. The first section 71a corresponds to a section at a tip of the example rotor blade, and the last section 711 corresponds to a section at a root of the example rotor blade. The x-axis corresponds to the number of points used to measure the curvature. As shown in FIG. 7, a curvature for each section 71a-1 of the example rotor blade varies by section, and generally decreases as one gets closer to the root of the example rotor blade.

FIG. 8 illustrates a radius of curvature of an example rotor blade suction portion when α is 90 degrees. As shown in FIG. 8, the example rotor blade is divided into 12 sections, 71a-1, wherein the first section 71a corresponds to a section at the tip of the example rotor blade, and the last section 711 corresponds to a section at the root of the example rotor blade. As shown in FIG. 8, a radius of curvature for each section 71a-1 of the example rotor blade varies by section, and generally decreases as one gets closer to the root of the example rotor blade.

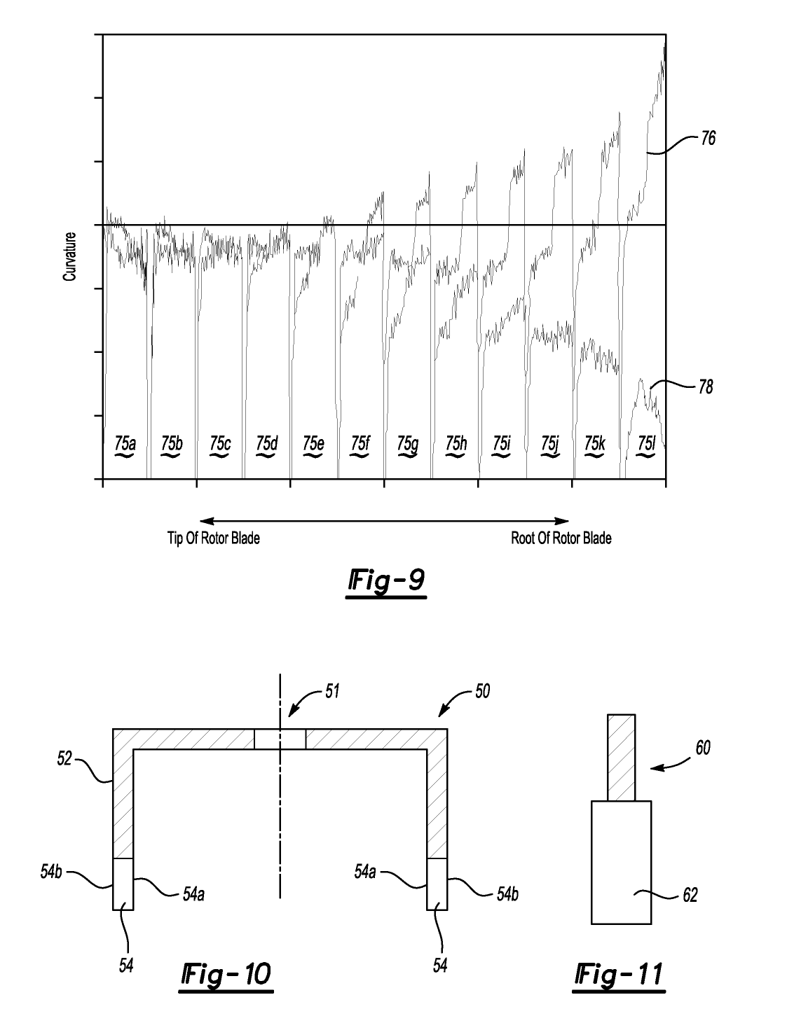

FIG. 9 illustrates a curvature of an example rotor blade suction portion 78 and an example rotor blade pressure portion 76 when α is 70 degrees. In the example of FIG. 9, the example rotor blade is divided into 12 sections 75a-1. As shown in FIG. 9, when α is 70 degrees instead of 90 degrees as in FIG. 7, there is a significant overlap between the curvature of the suction portion 78 and pressure portion 76, particularly in sections 75a-e. in FIG. 9, the curvature of the pressure portion 76 increases as one gets closer to the root of the example rotor blade, and the curvature of the suction portion 78 decreases as one gets closer to the root of the example rotor blade.

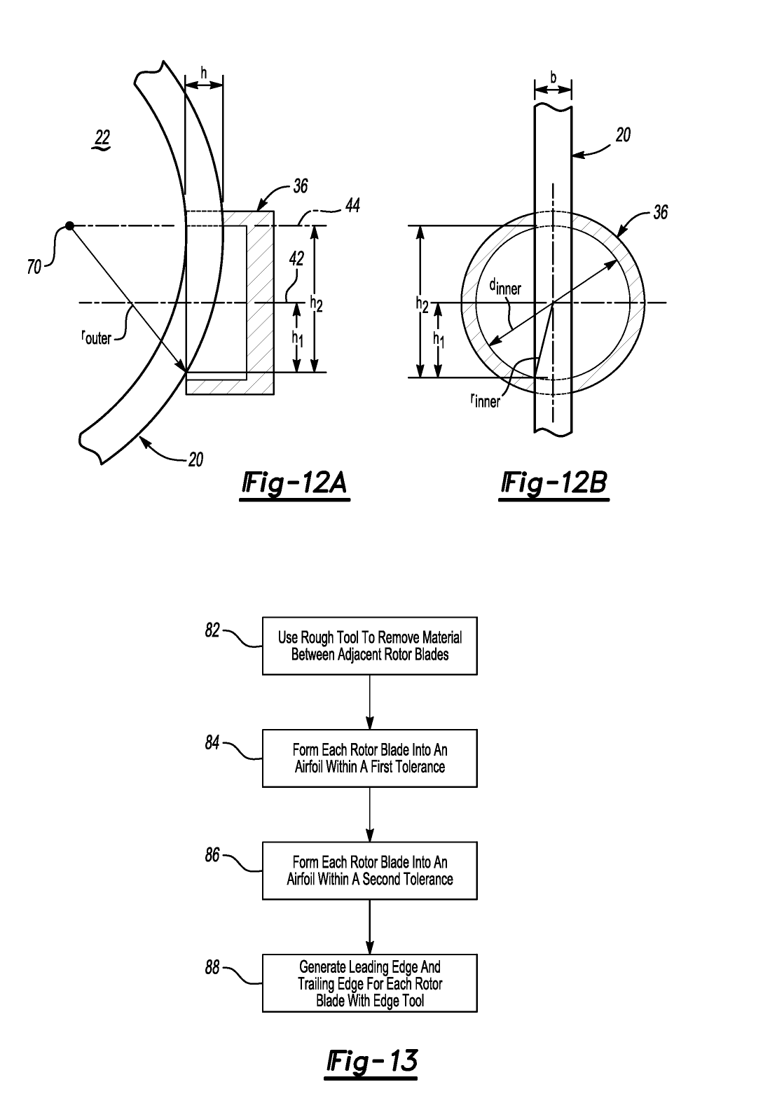

FIG. 13 is a flow chart illustrating an example method of forming a plurality of rotor blades into airfoils. In a first step 82, a tool is used to remove material between adjacent rotor blades. The material is removed in discrete steps from an outside radius of an IBR to a total length of a desired rotor blade. A magnitude of the discrete steps is determined based on the flexibility of a given rotor blade. If a given rotor blade is highly flexible, a smaller discrete step could be used, and if a given rotor blade is less flexible, a larger discrete step could be used. Step 82 may be repeated to remove material between every rotor blade on an IBR.

FIG. 10 illustrates a cross section of a rough tool 50 that may be used in the step 82. The rough tool 50 comprises a cylindrical body portion 52 and a circumferential forming portion 54, and is operable to rotate about a central tool axis 51. In one example, the forming portion 54 performs a grinding function when contacting a rotor blade or pre-form. As shown in FIG. 10, a cross section of the forming portion 54 is rectangular, and an inner side 54a and an outer side 54b of the forming portion 54 of the rough tool 50 are not curved like the forming portion 38 of the tool 36 as shown in FIG. 4b. In one example the cylindrical body 52 is made of steel and the forming portion 54 is made of cubic boron nitride. Again, other materials may be used. While a rough tool 50 has been described for use in step 82, it is understood that it would also be possible to use the tool 36 for this step.

A second step 84 is to form each rotor blade into an airfoil within a first tolerance. As shown in FIG. 3a, the tool 36 is positioned to contact a first side of a rotor blade. In one example, the tool 36 first contacts the first side of a rotor blade at an outer tip of the rotor blade. The tool 36 then rotates to form a first airfoil section at the tip of the rotor blade. The tool 36 is then moved closer to the root of the rotor blade, and is rotated to form a second airfoil section. The tool is then repeatedly moved and rotated until the tool reaches a root of the rotor blade and an entire side of the rotor blade has been formed into an airfoil shape.

As shown in FIG. 3b, the tool is then moved to contact a second side of a rotor blade. As described above, the tool 36 starts at an outer tip of the rotor blade, and is rotated and moved until the tool has formed the entire second side of the rotor blade into an airfoil shape. In one example the tool 36 forms a suction side 26 of a rotor blade 24 and then forms a pressure side 28 of a rotor blade 24. However, as mentioned previously, it is understood that the tool 36 could also form a pressure side of a given airfoil and then a suction side of the airfoil instead of creating a suction side first.

A third step 86 in the example IBR manufacturing process is to further form each rotor blade into an airfoil shape within a second tolerance that is narrower than the first tolerance. In this step a surface of each rotor blade is ground to have a smoother surface. If desired, a cylindrical tool with a forming portion having a finer grit size than the forming portion 38 used in the second step may be used. However, it is understood that the same forming portion 38 could also be used for the second and third steps.

A fourth step 88 is to generate a leading edge 30 and a trailing edge 32 for each rotor blade as shown in FIG. 2. FIG. 11 illustrates an edge tool 60 with a forming portion 62 that may be used in this fourth step of forming a leading edge 30 and a trailing edge 32 for each rotor blade 24. In one example, the forming portion 62 performs a grinding portion when contacting a rotor blade or pre-form. The process of using the edge tool 60 to form a leading edge 30 and a trailing edge 32 would be clear to one of ordinary skill in the art.

The dimensions of the tool 36 will vary depending on the dimensions of a desired IBR and the dimensions of a desired rotor blade on the IBR. It is therefore necessary to design the tool 36 to accommodate the dimensions of a desired IBR.

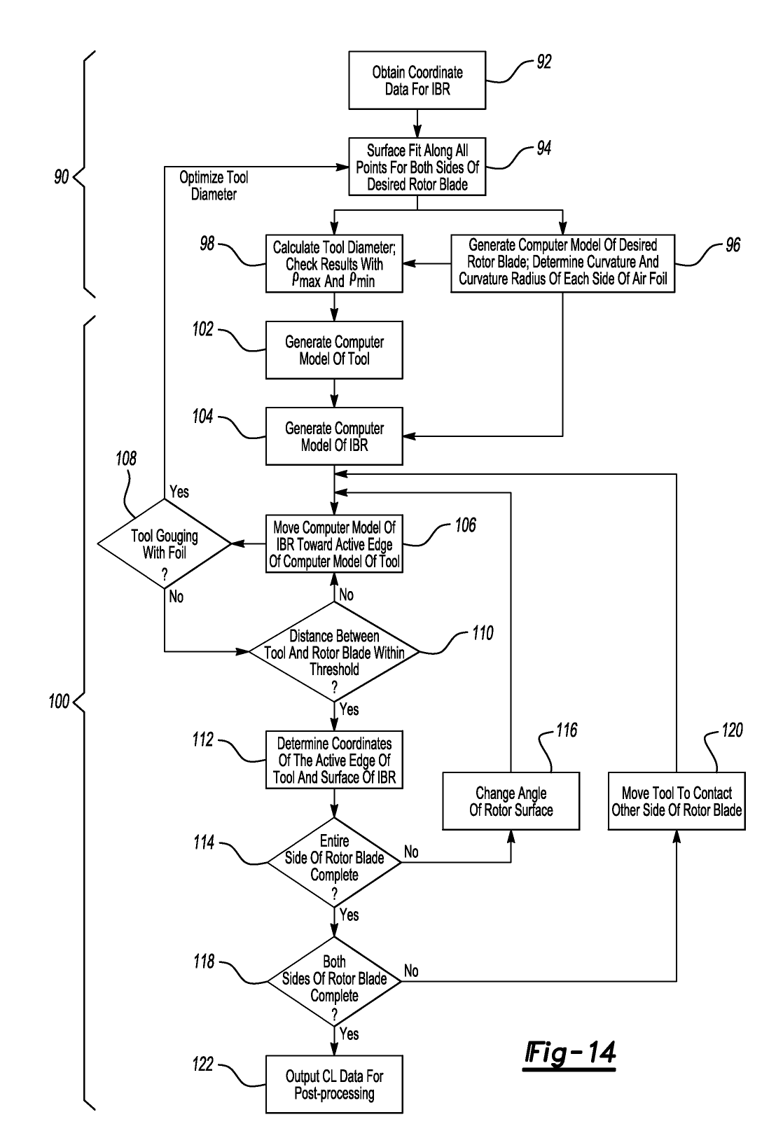

FIG. 14 is a flow chart illustrating an example method 90 of designing the tool 36. A first step 92 is to obtain coordinate data for at least a minimum number of points on each section of a desired rotor blade. In one example the minimum number of points is 30 points. If a computer model of a desired rotor blade is available, coordinate data could be obtained from the computer model.

A second step 94 is to perform a surface fit along all points for both a pressure and a suction side of the desired rotor blade. In one example, a non-uniform rational B-spline (“NURBS”) technique is used for the step 94. A computer model of the desired rotor blade is then generated in a third step 96. Step 96 also includes determining a curvature and a radius of curvature at each section of the desired rotor blade, for both a pressure and a suction side of the desired rotor blade. In one example, the curvature and radius of curvature are determined using software, such as MATLAB.

A fourth step 98 of designing the tool 36 involves calculating an inner and an outer diameter of the tool 36. An outer diameter of the tool 36 may be determined using equation #1 as shown below:

$${h}_{2}^{2} = {( \frac{{d}_{outer}}{2} )}^{2} - {( \frac{{d}_{outer}}{2} - h )}^{2} \qquad equation \#1$$

where dₒᵤₜₑᵣ is an outer diameter of the tool 36;
h is a height of a desired rotor blade; and
h₂ is a distance between an inner side of the tool 36 and a position of contact between the forming portion 38 and a desired rotor blade as shown in FIG. 12a.

An inner diameter of the tool 36 may be determined using equation #2 as shown below:

$${h}_{1}^{2} = {( \frac{{d}_{inner}}{2} )}^{2} - {( \frac{b}{2} )}^{2} \qquad equation \#2$$

where h₁ is a distance between a center of the tool 36 and a point of contact between the tool 36 and the IBR 20 as shown in FIG. 12b;
dᵢₙₙₑᵣ is an inner diameter of the tool 36; and
b is a width of an IBR.

As shown in FIG. 12a, a point 70 is located at a center of the IBR. The value of

$$\frac{{d}_{outer}}{2}$$

from equation #1 is the equivalent of rₒᵤₜₑᵣ, and the value of

$$\frac{{d}_{inner}}{2}$$

from equation #2 is the equivalent of rᵢₙₙₑᵣ. Once a value for dᵢₙₙₑᵣ and dₒᵤₜₑᵣ have been calculated, a check should be performed to verify that the values fulfill the conditions set forth in equation #3, equation #4, and equation #5 as shown below:

$$\begin{matrix}{h}_{2} < \frac{{d}_{inner}}{2} + {h}_{1} & equation \#3 \\ {d}_{inner} > {h}_{2} + \frac{{b}^{2}}{4 {h}_{2}} & equation \#4 \\ {d}_{inner} > \sqrt{h ( {d}_{outer} - h )} + \frac{{b}^{2}}{4 \sqrt{h ( {d}_{outer} - h )}} & equation \#5\end{matrix}$$

Step 98 also includes verifying that the tool 36 will not undesirably gouge an adjacent rotor blade during operation. This includes verifying that the tool outer radius rₒᵤₜₑᵣ is less than ρₘᵢₙ, which is the minimum curvature radius of the pressure side 28 of a rotor blade 24. This also includes verifying that the tool inner radius rᵢₙₙₑᵣ is greater than ρₘₐₓ, which is the maximum curvature radius of the suction side 26 of a rotor blade 24. If both of these conditions are satisfied, then undesirable gouging can be avoided, and a design of the tool 36 may be completed.

Once the dimensions of the tool 36 have been designed, it is useful to generate a tool path that the tool may follow to form a rotor blade into an airfoil. Data for the tool path may be transmitted to a computer numerical control (“CNC”) machine which would then be able to operate the tool 36 to form a rotor blade or a plurality of rotor blades into an airfoil shape.

In addition to illustrating the example method 90 of designing the tool 36, FIG. 14 also illustrates an example method 100 of generating a path for the tool 36. In a first step 102, a computer model of the tool 36 is generated. In one example, computer-aided design (“CAD”) software is used to generate the computer model of the tool 36. Input parameters of the computer model of the tool 36 include tool outer diameter dₒᵤₜₑᵣ, tool thickness, tool height hₜₒₒₗ, and also coordinate data for a root of a desired rotor blade.

In a second step 104, a computer model of the IBR 20 is generated. In one example, CAD software is used to generate the computer model of the IBR 20. Input parameters of the computer model of the IBR 20 include coordinate data for a desired rotor blade, a quantity of desired rotor blades, a diameter of an IBR hub 22, an IBR thickness b, and a blending curve between the desired rotor blade and the IBR hub 22.

The computer model of the tool 36 and the computer model of the IBR 20 are then used to determine a tool path. In a step 106, the computer model of the tool 36 is moved to simulate contact between an active edge of the tool 36 and a first side of a rotor blade on the IBR.

At this point, a check 108 is performed to verify that the computer model of the tool 36 is not undesirably contacting an adjacent rotor blade. If there is undesirable contact, a diameter of the tool 36 must be modified, and one would return to step 94. However if there is no undesirable contact, then one would proceed to a distance check 110 between an active edge of the computer model of the tool 36 and a blade of the computer model of the IBR. If the distance is greater or equal to a threshold, then one would return to step 106. However if the distance is less than the threshold, then one would proceed to a step 112.

In a step 112, a set of coordinates for an active edge of the tool and a surface of the IBR are recorded in memory. In a step 114, a check is performed to determine if an entire side of the rotor blade has been completed. If the entire side is not complete, then an angle of the rotor surface is changed in a step 116, and steps 106-114 are repeated until an entire side of the rotor blade is complete. Then, in step 118 a check is performed to determine if both sides of the rotor blade are complete. If both sides are not complete, the tool is moved to simulate contact with a second side of the rotor blade in a step 120. However, it is understood that instead of moving the tool in step 120, the IBR could be moved. Steps 106-118 are then repeated until the tool has simulated contact with the entire second side of the desired rotor blade of the computer model of the IBR 20.

The tool coordinates could be used to generate a cutter location (“CL”) data file, which could then be further processed in step 122. In one example, step 122 comprises generating a data file for a CNC machine from the CL data file.

In one example, the threshold of step 110 is a first threshold, and once steps 106-120 have been performed and coordinate data is available for the tool simulating contact with the entire rotor blade, the steps 106-120 are performed again using a second threshold that is less than the first threshold. In this example, the first threshold corresponds to forming a rotor blade within a first tolerance, and the second threshold corresponds to forming the rotor blade within a second tolerance as described in the example IBR manufacturing process of FIG. 13.

Once tool paths are determined for forming a rotor blade into an airfoil within a first threshold and a second threshold, a CNC machine may be instructed to repeat the tool paths for each blade of an IBR as described in FIG. 13.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of designing a tool path for forming a rotor blade including an airfoil portion, comprising:
generating a computer model of a cylindrical tool operable to form a rotor blade including an airfoil portion;
generating a computer model of a rotor having a plurality of the rotor blades;
generating a first tool motion corresponding to forming a first airfoil portion with a first side of the tool; and
generating a second tool motion corresponding to forming a second airfoil portion with a second side of the tool.

2. The method of claim 2, wherein the first airfoil portion corresponds to an airfoil suction portion, and the second airfoil portion corresponds to an airfoil pressure portion.

3. The method of claim 1, wherein the first airfoil portion corresponds to an airfoil pressure portion, and the second airfoil portion corresponds to an airfoil suction portion.

4. The method of claim 1, wherein the steps of generating a first tool motion corresponding to forming a first airfoil portion and generating a second tool motion corresponding to forming a second airfoil portion include:
a) simulating contact between an active edge of the computer model of the tool with the computer model of the rotor blade;
b) verifying that the computer model of the tool does not undesirably contact an adjacent rotor blade;
c) verifying that a distance between the computer model of the tool and the computer model of the rotor blade is within a threshold;
d) storing coordinates of the computer model of the tool and of the computer model of the rotor blade in memory; and
e) repeating steps 1-4 until the computer model of the tool has simulated contact with an entire surface of the computer model of the rotor blade.

5. The method of claim 4, wherein steps 1-5 are performed within a first threshold corresponding to a first tolerance, and are then performed within a second threshold corresponding to a second tolerance, wherein the second tolerance is less than the first tolerance.

6. The method of claim 1, wherein the step of generating a computer model of a rotor having a plurality of the rotor blades includes:
obtaining coordinates corresponding to a height of a rotor blade;
obtaining a desired quantity of rotor blades;
obtaining a diameter and a thickness of a rotor hub; and
obtaining a blending curve between the rotor blade and the rotor hub.
